(19) United States
(12) Patent Application Publication
(10) Pub. No.: US 2012/0001792 A1
(43) Pub. Date: Jan. 5, 2012

(54) Measuring device with a measuring section and a reference section

(75) Inventors: Dipl.-Ing. Ernst Halder, Renningen (DE); Peter Dingler, Aalen-Ebnat (DE)

(73) Assignee: Horst Siedle GmbH & Co. KG

(21) Appl. No.: 13/067,618

(22) Filed: Jun. 15, 2011

(30) Foreign Application Priority Data
Jul. 3, 2010 (DE) 10 2010 026 020.7

(51) Int. Cl. G01S 13/06; G01M 15/06; G01S 15/06

(52) U.S. Cl. 342/118; 367/99; 73/114.28

(57) ABSTRACT

A measuring device is disclosed. In at least one embodiment, the measuring device includes a waveguide that extends into a bore, wherein the bore and the waveguide contain a medium and wherein the waveguide and the bore are displaceable relative to each other. In at least one embodiment, the measuring device further includes at least one device for coupling in and coupling out of waves into the waveguide, wherein the waves transition from the waveguide into the bore, wherein the waves travel through a measuring section inside the bore, and wherein the waves travel inside the waveguide through a constant reference section.

### PRIORITY STATEMENT

The present application hereby claims priority under 35 U.S.C. §119 on German patent application number DE 10 2010 026 020.7 filed Jul. 3, 2010, the entire contents of which are hereby incorporated herein by reference.

### FIELD

At least one embodiment of the invention generally relates to a measuring device with a measuring section.

### BACKGROUND

Measuring devices are known, for example, from the field of magneto-restrictive measuring technology where they are used, for example, to determine the position of a piston within a hydraulic cylinder. One disadvantage of the magneto-restrictive measuring devices is that they do not have a reference section which results in increased expenditure and thus also increased costs in view of the accuracy of the measurement.

### SUMMARY

In at least one embodiment of the present invention, a simpler and thus also more cost-effective measuring device is created.

At least one embodiment of the invention is directed to a measuring device.

At least one embodiment of the invention provides for a constant reference section, having the advantage that environmental influences can be compensated for with relatively little expenditure. As a result, the accuracy of the measurement is simultaneously increased in a simple manner.

It is particularly advantageous if the reference section is longer than the measuring section, thus making it easy to further increase the accuracy of the measurement.

It is particularly advantageous if the wave is an ultrasonic wave or an electro-magnetic wave, thus making it possible to use known measuring and evaluation methods.

The ultrasonic wave usefully should be generated in such a way that it has only a single frequency or at least that a single frequency is dominant, wherein the electromagnetic wave should be generated such that it has only a single mode. The receiving and evaluating of the reflected measuring wave can thus be simplified, wherein this has the additional advantage of avoiding interferences caused by super-imposed frequencies and/or modes, thereby making it possible to further increase the measuring accuracy.

### BRIEF DESCRIPTION OF THE, DRAWINGS

Additional features, options for use and advantages of the invention are derived from the following description of example embodiments of the invention, which are shown in the Figures of the drawings. All therein described or illustrated features, either by themselves or in any combination thereof, represent the subject matter of the invention, regardless of how they are combined in the patent claims or how these refer back, as well as independent of the formulation and/or representation of said features in the specification and/or the drawings.

FIG. 1 of the drawings shows a schematic longitudinal section through a first example embodiment of a measuring device according to the invention.

FIG. 2 shows a schematic longitudinal section through a second example embodiment of a measuring device according to the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The examples of measuring devices explained in the following relate to the use of a cylinder or the like and are used for measuring the position and/or the location of an adjustable piston inside the cylinder. It is understood that the described measuring devices, if applicable correspondingly adapted, can also be used for other applications, for example for measuring the displacement on machine tools.

The cylinder for the above-explained measuring devices is filled at least partially with a medium, in particular with a liquid. It is understood that for a different application, any other type of medium can also be used in place of the liquid, such as a gas or a vacuum.

The measuring and evaluation method, explained in the following, is furthermore based in general on the ultrasonic technology. In this respect, it is also understood that the described measuring and evaluation method, if applicable correspondingly adapted, can also be based on different technologies, for example the radar technology.

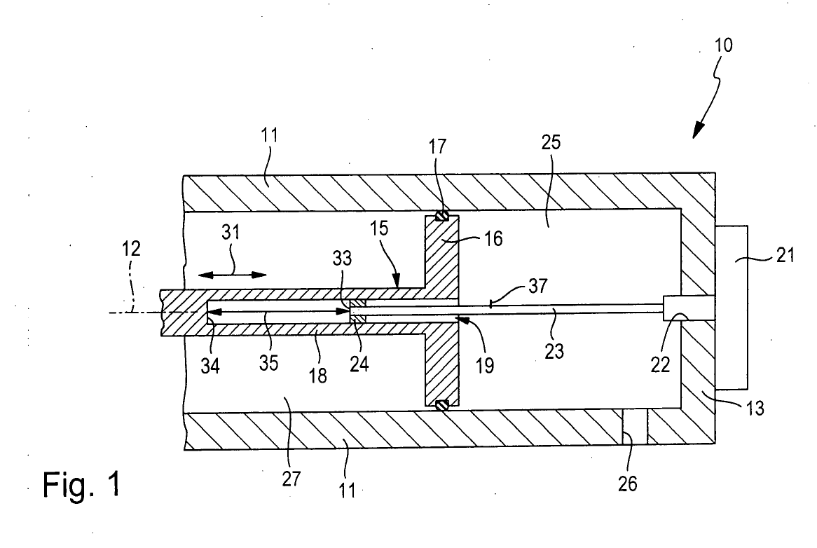

FIG. 1 shows a measuring device 10 with a cylinder 11, having a longitudinal axis 12, wherein one of the end faces of the cylinder is closed off with an end wall 13. The other end face of the cylinder 11 is not shown in further detail in FIG. 1.

The cylinder 11 contains a piston 15 on the inside which can move along the longitudinal axis 12. The piston 15 comprises a disc-shaped piston bottom 16 which is provided with a seal 17 around its circumference. During the displacement of the piston 15 in longitudinal direction, the seal 17 slides along the inside surface of the cylinder 11.

The piston 15 comprises a piston rod 18 that is oriented in the direction of the longitudinal axis 12 and is connected approximately in the center to the piston bottom 16 and projects from the piston bottom 16 on the side facing away from the end wall 13. The piston rod 18 contains a bore 19 that is aligned coaxial to the longitudinal axis 12 and is accessible from the side of the piston bottom 16 which faces the end wall 13.

A sensor housing 21 for accommodating an electric circuit is arranged on the end wall 13, outside of the cylinder 11. The end wall 13 contains approximately in the center an opening 22 through which the sensor housing 21 extends into the cylinder 11 inside space. In this region of the sensor housing 21, at least one device is provided for coupling in and coupling out of waves, in particular a transmitting/receiving antenna or transceiver, wherein it is understood that a separate transmitting antenna and receiving antenna can also be provided.

The cylinder 11 contains a waveguide 23 on the inside which is embodied rod-shaped in the form of a hollow cylinder and is oriented coaxial to the longitudinal axis 12. The waveguide 23 in particular is made of a metal. The waveguide 23 is connected to the region of the sensor housing 21 which extends on the inside of the cylinder 11 and which accommodates the device(s) for coupling in and coupling out of waves.

It is understood that the waveguide 23 can also have a non-circular cross section and can include a different material, for example a metal-coated plastic. A dielectric waveguide can furthermore be used in place of the waveguide 23.

The waveguide 23 extends into the bore 19 of the piston rod 18 and dips into this bore 19. The waveguide 23 has a slightly smaller diameter than the bore 19 in the piston rod 18, so that a liquid or a gas can flow from the waveguide 23 into the bore 19 and vice versa.

At its exposed end, the waveguide 23 is provided with a guide element 24 which functions to guide the waveguide 23 inside the bore 19. The guide element 24 is composed of a material which strongly dampens the wave propagation. For example, the guide element 24 can be composed of a high-loss plastic material with respect to the wave propagation or it can be composed of a plastic material reinforced with metal fibers or it can include metal.

The guide element 24 in this case is embodied such that a liquid can pass through without problem. For example, the guide element 24 can be provided with holes which are small, however, when compared to the wavelength of a propagating wave. The distance between the guide elements 24 and the bore 19 should furthermore be as short as possible.

A liquid is present in a region 25 between the end wall 13 and the piston bottom 16, wherein for the present example embodiment this liquid is oil, in particular oil with a dielectric constant of approximately ∈ᵣ=4. The liquid fills the total region 25, including the bore 19 in the piston rod 18, as well as the inside of the waveguide 23. As mentioned, the guide element 24 does not have a sealing function, so that liquid is present inside the bore 19, on both sides of the guide element 24.

In this region 25, between the end wall 13 and the piston bottom 16, liquid can be supplied via an opening 26 in the cylinder 11, or liquid can flow out of the region 25 through this same opening 26. A liquid such as oil can also be present in a region 27, on the side of the piston bottom 16 which is located opposite the end wall 13. For this, the seal 17 along the circumference of the piston bottom 16 is embodied sealing, such that no liquid can flow from the region 25 into the region 27 or vice versa.

If additional liquid is supplied to the region 25 via the opening 26, the pressure inside the region 25 increases which results in the piston bottom 16 and thus the complete piston 15 moving in the direction of the region 27, meaning to the left in FIG. 1. On the other hand, if liquid flows out of the region 25 the pressure in the region 25 is reduced and the piston 15 thus moves to the right in FIG. 1.

A movement of the piston 15 also results in a movement of the hollow-drilled piston rod 18, wherein this is indicated in FIG. 1 with a double arrow 31. Since the waveguide 23 is fixedly connected to the sensor housing 21, the movement of the piston rod 18, in turn, causes the waveguide 23 to dip more or less deeply into the bore 19 of the piston rod 18. The arrow 31 therefore represents a displacement of the bore 19 relative to the waveguide 23.

In FIG. 1, the exposed end of the waveguide 23 is marked with the reference numbers 33 while the bottom of the bore 19 is given the reference number 34. This results in a distance 35 between the exposed end 33 of the waveguide 23 and the bottom 34 of the bore 19, wherein this distance is marked with a double arrow in FIG. 1. This distance 35 increases and decreases with the movement 31 of the piston 15 inside the cylinder 11. The distance 35 represents the depth at which the waveguide 23 dips into the bore 19 and thus the position and/or the location of the piston 15 inside the cylinder 11.

A wave is coupled into the liquid-filled waveguide 23 with the aid of the device(s), accommodated inside the sensor housing 21, for coupling in and coupling out of waves. The wave is guided by the waveguide 23 and propagates over the length of the waveguide 23 until it reaches the exposed end 33. At the exposed end 33 of the waveguide 23, the wave at least partially transitions from the waveguide 23 to the bore 19 in the piston rod 18. Inside the bore 19, the wave propagates in the direction toward the bottom 34 of the bore 19. The wave is reflected at the bottom 34 of the bore 19, such that is moves once more in the direction of the exposed end 33 of the waveguide 23 where the wave again transitions from the bore 19 to the waveguide 23. The wave then moves along the waveguide 23 and is received by the device(s) inside the sensor housing 21 for the coupling in and coupling out of waves.

With the damping feature of the guide element 24 it is achieved that during the above-described wave propagation, the wave moving from the waveguide 23 into the bore 19 is not “deflected” and beamed into the region 25 of the cylinder 11. The guide element 24 thus ensures that the region 25 essentially remains field-free and, in particular, no resonance phenomena is formed in this region which could influence the above-described wave propagation. The guide element 24 consequently supports and/or ensures the above described transition of the wave from the waveguide 23 into the bore 19.

Alternatively or in addition thereto, the aforementioned transition of the wave from the waveguide 23 into the bore 19 can also be supported and/or ensured by coating the outside of the waveguide 23 with a layer that dampens the wave propagation. For example, the waveguide 23 can be provided on the outside with a high-loss plastic layer for the wave propagation.

As mentioned, at the exposed end 33 of the waveguide 23 the wave transitions only partially from the waveguide 23 to the bore 19 in the piston rod 18. A different portion of the wave is reflected during this transition and immediately moves back inside the waveguide 23 toward the aforementioned device(s) for the coupling in and coupling out of waves.

For the present embodiment, the waveguide 23 thus forms a reference section which matches the length of the waveguide 23, independent of the depth at which the waveguide 23 dips into the bore 19. In contrast thereto, the distance 35 inside the bore 19 represents a changeable measuring section which depends on the position of the piston 16 and thus on the depth at which the waveguide 23 dips into the bore 19.

For the present example, the reference section is longer than the measuring section which follows from the fact that on the one hand the measuring section can maximally correspond to the length of the bore 19 in the piston rod 18 and, on the other hand, the waveguide 23 forming the reference section must have at least the length of the bore 19. If applicable, however, it can also be longer as is the case for the present example.

As explained, the diameter of the waveguide 23 is only slightly smaller than the diameter of the bore 19 in the piston rod 18. As a result, the wave is guided by the bore 19 in the region of the measuring section, meaning in the region of the distance 35, in a similarly defined manner as in the region of the waveguide 23. Defined conditions therefore exist for the wave propagation in the region of the measuring section. In particular, no multiple reflections of the wave or the like occur in the region of the measuring section because of this defined guidance. As a result of these defined conditions for the wave propagation in the region of the measuring section, a change in the length of the measuring section, meaning a change in the length of the distance 35, essentially has no influence on the wave propagation.

As previously mentioned, the present example embodiment shown in FIG. 1 is based on the ultrasonic technology. In this case, a longitudinal ultrasonic wave is generated by the device(s) for coupling in and coupling out of waves and is coupled into the waveguide 23. The ultrasonic wave is generated for this in such a way that it only has a single frequency, if possible, or at least that a single frequency is dominating and that if possible no harmonic waves are present. This ultrasonic wave then propagates in the aforementioned manner, until it is again received by the aforementioned device(s).

As previously explained, the wave transitions at the exposed end 33 of the waveguide 23 from the waveguide 23 to the bore 19. This represents a jump for the wave, meaning from the conditions predetermined by the waveguide 23 to the conditions predetermined by the bore 19. Critical with the aforementioned conditions are in particular the diameter of the waveguide 23 and the diameter of the bore 19, wherein these in the final analysis determine the jump.

This jump is configured such that the wave if possible does not change during the jump or transfer. In particular, the jump is configured such that the generated dominating mode of the ultrasonic wave is maintained during the jump and that the ultrasonic wave does not have a different or additional dominating mode following the jump.

For the present example, the jump is configured in particular in such a way that the waveguide 23 has a diameter in the range of approximately 5 mm to approximately 10 mm, in particular a diameter of approximately 8 mm. The bore 19 should have a diameter in the range of approximately 6 mm to approximately 15 mm, in particular a diameter of approximately 10 mm.

For the present example embodiment, an ultrasonic wave is thus excited by the device(s) accommodated in the sensor housing 21 for coupling in and coupling out of waves, wherein this wave if possible has only a single frequency. During the transition from the waveguide 23 to the bore 19, this single frequency is maintained. The ultrasonic wave is reflected on the bottom 34 of the bore 19, so that subsequently it can transition again unchanged into the waveguide 23. The reflected ultrasonic wave thus has the same frequency in the waveguide 23 as the initially excited ultrasonic wave.

On the whole, the ultrasonic wave thus propagates along the waveguide 23 and along the bore 19 in both directions, without changing its frequency which is achieved through a corresponding selection of the variables influencing the ultrasonic wave. In general this refers to the way in which the transition between the waveguide 23 and the bore 19 is configured and, in particular, refers to one or several of the following variables: the frequency of the ultrasonic wave, the conditions of the waveguide 23 and the bore 19 and especially their diameters, the dielectric constant ∈ᵣ of the liquid inside the bore 19 and the waveguide 23. By making a corresponding selection of one or several of the aforementioned variables, it can be achieved that the ultrasonic wave does not change during the propagation in the waveguide 23 and the bore 19, in particular that the frequency of the ultrasonic wave does not change.

As previously explained, the wave only partially transitions to the bore 19 at the exposed end 33 of the waveguide 23. The other portion of the wave is reflected at the exposed end 33 and then moves immediately back into the waveguide 23, traveling in the direction of the sensor housing 21.

The device(s) for coupling in and coupling out of waves, which are located in the sensor housing 21, therefore receive on the one hand the share of the wave reflected at the bottom 34 of the bore 19, which is henceforth referred to as the measuring wave and, on the other hand, the share of the wave reflected at the exposed end 33 of the waveguide 23, which in the following is called the reference wave. The reference wave in the process travels twice over the previously explained, constant reference section while the measuring wave travels a distance which corresponds to two times the changeable measuring section as well as two times the constant reference section.

The electric circuit housed in the sensor housing 21 functions to compare the measuring wave to the initially generated wave that is fed into the waveguide 23. In dependence on this comparison, the circuit generates a measuring signal which corresponds to the distance 35 and thus the position and/or location of the piston 15 inside the cylinder 11. This measuring signal is generated by the circuit based on known measuring and evaluation methods of the ultrasonic technology or a combination thereof.

In the ultrasonic technology, this measuring signal in particular is derived from the time delay between the step of coupling in the initial ultrasonic wave into the fluid contained in the waveguide 23 and the step of receiving of the measuring wave.

The reference wave can thus be used to compensate for environmental influences, for example temperature and/or pressure influences and/or changes in the fluid that is used. For example, the speed at which an ultrasonic wave travels in a fluid depends on the existing pressure. This dependence can be determined with the aid of the constant reference section and the associated reference wave and can thus be considered for the measuring wave.

A calibration mark 37 can furthermore be affixed inside the waveguide 23, which reflects as reference wave at least a portion of the wave that is initially coupled into the waveguide 23. Such a calibration mark 37 can be realized, for example, in the form of an interfering location in the waveguide 23. In dependence on the arrangement of the calibration mark 37, the reference section can also be shorter than the measuring section, wherein it is understood that several such calibration marks can also be provided. In this way, different or additional reference waves can be generated which can be used for the compensation measures.

A metal insert can furthermore be arranged on the bottom 34 of the bore 19 which has a flat surface and is aligned transverse to the longitudinal axis 12 when it is fully inserted. The flat surface of the insert thus provides a reflection surface for the waves.

In particular, the insert can be embodied such that when it is fully inserted a cavity is provided below the flat surface, meaning in the region at the far end of the bore 19 which is embodied as a blind bore. Any gas bubbles that may collect at the end of the bore 19 are thus collected inside the cavity of the insert. The gas bubbles therefore cannot influence the waves because the waves are reflected at the above-positioned surface of the insert.

Radar technology can alternatively also be used, as previously mentioned. In that case, a transverse magnetic wave with constantly changing frequency is excited, for example in the form of a triangular or saw-tooth shaped frequency which is ascending and descending over time, in particular the so-called FMCW radar technology (FMCW=frequency modulated continuous wave).

For example, the generated radar wave can have a median frequency in the range between approximately 22 GHz and approximately 26 GHz. In particular, the median frequency can be approximately 24 GHz.

Electromagnetic waves of this type can have one or several different field configurations, in short modes. On the one hand, this can refer to a so-called TM and/or E mode (TM=transversal-magnetic; E=electric). In that case, the magnetic component of the electromagnetic wave is perpendicular to its direction of propagation while the electrical field component points in propagation direction of the electromagnetic wave. On the other hand, it can refer to a basic mode or an optional higher mode, for example a 01 or a 02 mode, wherein the numbers among other things correspond to the order of the Bessel function which describes the field course in radial direction. Finally, a combination thereof is possible as well.

In the case of radar technology, the electromagnetic wave is excited in such a way that it only has a single mode, in particular the E01 mode. In that case, the wave is formed essentially rotation-symmetrical inside the waveguide 23. The electrical field lines of the E01 mode within the hollow-cylindrical waveguide 23, in particular, are essentially formed radially around its longitudinal axis. To generate the wave with the E01 mode, it is sufficient to provide a single transmitting/receiving antenna.

As explained, the electromagnetic wave transitions at the exposed end 33 of the waveguide 23 from the waveguide 23 to the bore 19. This represents a jump for the wave, meaning from the conditions existing in the waveguide 23 to the conditions as they exist in the bore 19. In particularly the diameter of the waveguide 23 and the diameter of the bore 19 are critical factors which in the final analysis determine the aforementioned jump or transition.

The jump should be configured such that it does not cause a change in the electromagnetic wave, if possible, and such that before and after the jump, the electromagnetic wave still is in the E01 mode as the single excited mode.

In connection with the radar technology, we otherwise refer to the previously provided explanations for the example embodiment shown for the ultrasonic technology. The single generated frequency, explained for the ultrasonic technology, in this case corresponds to the excited E01 mode of the electromagnetic radar wave. Finally, the generated measuring signal is determined for the radar technology with the aid of known measuring and evaluation methods used for the radar technology, especially the FMCW radar technology.

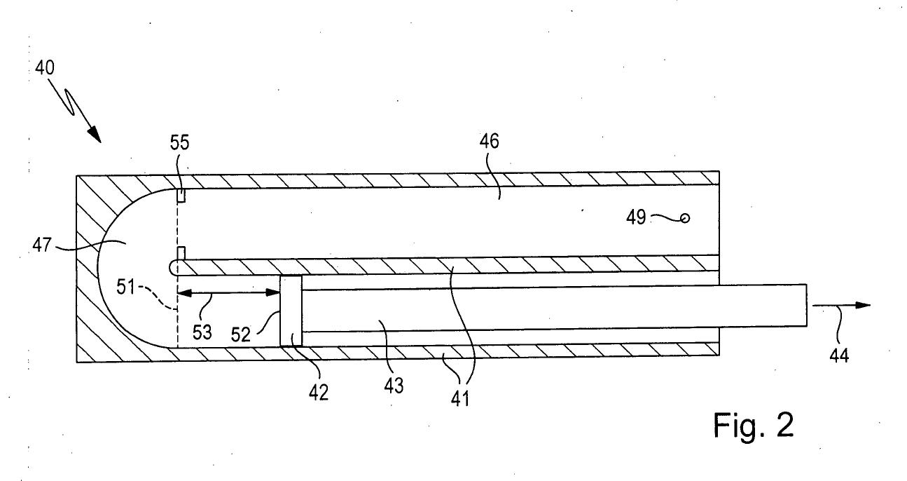

FIG. 2 shows a measuring device 40 provided with a cylinder 41 with therein position, displaceable piston 42. The piston 42 is provided with a piston rod 43 which projects from the measuring device 40. The piston rod 43 together with the piston 42 can thus be moved back and forth from the outside in the direction of the double arrow 44.

Parallel to the cylinder 41, a bore 46 is provided which is connected via a diverter 47 to the cylinder 41, wherein the diverter 47 is bent at an angle of 180 degrees. The bore 46 and the diverter 47 preferably have a circular cross section. It is understood that the cross sections of the cylinder 41, the piston 42, the bore 46 and/or the diverter 47 can also be embodied differently and can, for example, be square.

In the example embodiment shown in FIG. 2, the cylinder 41, the diverter 47 and the bore 46 have identical diameters, wherein it is understood that these diameters can also be different. In particular, it is possible that the diameter of the bore 46 is identical to that of the diverter 47, but that the diameter of the cylinder 41 is different.

The measuring device 40 can be produced, for example, from a metal profile section. The measuring device 40 is tightly sealed, in a manner not shown herein. The inside of the measuring device 40, in particular the cylinder 41, the bore 46 and the diverter 47 are filled with a medium, wherein this medium can be a liquid and especially oil. Alternatively, the medium can also be a gas or a vacuum. The piston 42 in this case is arranged non-sealing inside the cylinder 41, so that the medium can flow along the piston 42 during a piston movement.

Device(s) 49 for coupling in and coupling out waves are arranged at the end of the bore 46 which faces away from the diverter 47, wherein the device(s) can be a transmitting and receiving antenna.

In FIG. 2, the end of the diverter 47 that is facing the piston 42 is given the reference 51 and the side of the piston 42 that is facing away from the piston rod 43 is given the reference 52. This results in a distance 53 between end 51 of the diverter 47 and the side 52 of the piston 42, wherein this distance is marked with a double arrow in FIG. 2. This distance 53 increases and decreases with the movement of the piston 42 inside the cylinder 41. The distance 53 represents the depth at which the piston 42 plunges into the cylinder 41 and thus the position and/or location of the piston 42 inside the cylinder 41.

With the aid of the device(s) 49 for coupling in and coupling out of wave, a wave is coupled into the bore 46 that is filled with the medium. The wave is guided along the bore 46 and the diverter 47 and propagates along its length up to the end 51. At the end 51, the wave transitions from the diverter 47 to the cylinder 41. In the cylinder 41, the wave propagates in the direction toward the side 52 of the piston 42. At this side 52 of the piston 42, the wave is reflected so that it again moves in the direction toward the end 51 of the deflector 47 where the wave again transitions from the cylinder 41 to the deflector 47. The wave then travels along the deflector 47 and the bore 46 and is subsequently received by the device(s) 49 for coupling in and coupling out of waves which are located inside the bore 46.

In FIG. 2, a calibration mark 55, in particular embodied ring-shaped, is provided at the transition from the bore 46 to the deflector 47. At this calibration mark 55, the wave transitions only partially from the bore 46 into the deflector 47. A different portion of the wave is reflected during the transition and then moves back immediately along the bore 46 to the device(s) 49 for the coupling in and coupling out of waves.

It is understood that other or additional calibration marks can also be provided along the bore 46 and/or in the region of the deflector 47.

It is furthermore possible that the cylinder 41 and/or the bore 46 and/or the deflector 47 have an angular cross section, in particular a rectangular cross section.

Alternatively or in addition thereto, the aforementioned reflection can be caused by a change in the diameter of the deflector 47 and/or the bore 46, especially if the diameter of the deflector 47 is smaller than the diameter of the bore 46 and/or the cylinder 41. The change in the diameter in this case should take the form of a sharp-edged, ring-shaped jump. This represents a jump for the wave which causes the wave to be reflected, at least in part.

The distance between the bore 46 and, if applicable, also the deflector 47 up to the calibration mark 55 and/or the diameter jump thus forms a reference section which always has a specific length, independent of the depth at which the piston 42 dips into the cylinder 41. In contrast thereto, the distance 53 inside the cylinder 41 represents a changeable measuring section which depends on the position of the piston 42 and thus the depth at which the piston 42 dips into the cylinder 41.

The reference section is at least as long as the measuring section which follows from the fact that on the one hand, the maximum length of the measuring section can correspond to the length of the cylinder 41 while, on the other hand, the reference section measures at least the length of the bore 46 up to the calibration mark 55. If applicable, the section can also be longer, especially if the calibration mark 55 is provided in the region of the deflector 47.

The wave generated by the device(s) 49 can be an ultrasonic wave or a radar wave. In view of generating these waves, their propagation within the measuring device 40, as well as their subsequent evaluation, we point to the corresponding explanations provided in connection with the measuring device 10 shown in FIG. 1. With the measuring device 10 shown in FIG. 1, the reference section is formed by the waveguide 23 and the measuring section is formed by the distance 35 within the bore 19. For the measuring device 40, shown in FIG. 2, the reference section is formed by the bore 46 and, if applicable, the diverter 47 and the measuring section is formed by the distance 53 within the cylinder 41.

It is understood that the measuring device 40 can also be embodied without the deflector 47. In that case, the bore 46 and the cylinder 41 extend successively in the same direction and result in an elongated, tube-shaped design. The reference section in that case is formed only by the bore 46, wherein the reflection of the wave, as explained before, can be generated by the calibration mark 55 and/or the diameter jump.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A measuring device, comprising:
a waveguide that extends into a bore, wherein the bore and the waveguide contain a medium and wherein the waveguide and the bore are displaceable relative to each other; and
at least one device for coupling in and coupling out of waves into the waveguide, wherein the waves transition from the waveguide into the bore, wherein the waves travel through a measuring section inside the bore, and wherein the waves travel inside the waveguide through a constant reference section.

2. The measuring device according to claim 1, wherein a length of the measuring section corresponds to a depth at which the waveguide dips into the bore.

3. The measuring device according to claim 1, wherein the bore is a component of a piston which is installed displaceable inside a cylinder, so that the measuring section corresponds to the position of the piston in the cylinder.

4. The measuring device according to claim 3, wherein the waveguide is connected to a sensor housing on the cylinder, and wherein the sensor housing accommodates the at least one device for the coupling in and coupling out of waves.

5. The measuring device according to claim 1, wherein the waveguide is provided with a guide element for guiding the waveguide inside the bore, the guide element being composed of a material for damping the wave propagation.

6. The measuring device according to claim 1, wherein a diameter of the bore is only slightly larger than a diameter of the waveguide.

7. A measuring device, comprising:
a cylinder;
a diverter;
a piston that extends into the cylinder, wherein a medium is provided in the bore, the diverter and the cylinder, and wherein the piston and the cylinder are movable relative to each other; and
at least one device for coupling in and coupling out of a wave into the bore, wherein the waves transition from at least one of the bore and the diverter into the cylinder, wherein the waves in the cylinder travel through a measuring section, and wherein the waves in at least one of the bore and the diverter travel through a constant reference section.

8. The measuring device according to claim 7, wherein the measuring section corresponds to the position of the piston in the cylinder.

9. The measuring device according to claim 7, wherein the diverter is omitted and the cylinder and the bore extend successively in the same direction.

10. The measuring device according to claim 1, wherein the reference section is longer than the measuring section.

11. The measuring device according to claim 1, wherein the at least one device for the coupling in and coupling out of the waves is embodied for generating and receiving ultrasonic waves or electromagnetic waves.

12. The measuring device according to claim 11, wherein the ultrasonic waves are generateable to have only a single frequency, if possible, or at least one frequency which dominates.

13. The measuring device according to claim 11, wherein the electromagnetic waves are generateable in such a way to have only a single mode.

14. The measuring device according to claim 12, wherein the waves do not change at the transition from the reference section to the measuring section.

15. The measuring device according to claim 14, wherein the single frequency of the ultrasonic waves remain the same at the transition from the reference section to the measuring section.

16. The measuring device according to claim 15, wherein no additional frequency is generated for the ultrasonic waves at the transition from the reference section to the measuring section.

17. The measuring device according to claim 14, wherein a diameter of the reference section and a diameter of the measuring section are selected such that the waves do not change during the transition from the reference section to the measuring section.

18. The measuring device according to claim 1, wherein a measuring signal that corresponds to the measuring section is generateable in dependence on the generated waves and received measuring waves.

19. The measuring device according to claim 18, wherein environmental influences on the measuring signal are compensateable with the aid of the reference section.

20. The measuring device according to claim 2, wherein the bore is a component of a piston which is installed displaceable inside a cylinder, so that the measuring section corresponds to the position of the piston in the cylinder.

21. The measuring device according to claim 20, wherein the waveguide is connected to a sensor housing on the cylinder, and wherein the sensor housing accommodates the at least one device for the coupling in and coupling out of waves.

22. The measuring device according to claim 8, wherein the diverter is omitted and the cylinder and the bore extend successively in the same direction.

23. The measuring device according to claim 7, wherein the reference section is longer than the measuring section.

24. The measuring device according to claim 7, wherein the at least one device for the coupling in and coupling out of waves is embodied for generating and receiving ultrasonic waves or electromagnetic waves.

25. The measuring device according to claim 13, wherein the waves do not change at the transition from the reference section to the measuring section.

26. The measuring device according to claim 13, wherein the single mode of the electromagnetic waves remain the same at the transition from the reference section to the measuring section.

27. The measuring device according to claim 26, wherein no additional frequency is generated for the electromagnetic waves at the transition from the reference section to the measuring section.
